(19) United States
(12) Patent Application Publication
(10) Pub. No.: US 2024/0294088 A1
(43) Pub. Date: Sep. 5, 2024

(54) CUSTOMER-CENTRIC DYNAMIC CHARGING POINTS ASSESSMENT

(71) Applicant: FORD GLOBAL TECHNOLOGIES, LLC, Dearborn, MI (US)

(72) Inventors: Kai WU, Pittsburgh, PA (US); Dominique MEROUX, San Francisco, CA (US); Chen ZHANG, South Lyon, MI (US); Yan FU, Bloomfield Hills, MI (US); Geofrey SATTERFIELD, Van Buren Twp., MI (US)

(21) Appl. No.: 18/178,076

(22) Filed: Mar. 3, 2023

(51) Int. Cl. B60L 53/66; B60L 53/65

(52) U.S. Cl. CPC B60L 53/66; B60L 53/65

(57) ABSTRACT

Customer-centric dynamic charging station assessment is provided. A charger request is received from a vehicle, the charger request including an identifier of a sender of the charger request and a location of the vehicle. One or more charging stations in proximity to the location of the vehicle are identified. For each identified charging station, a user-specific charger score is computed using a plurality of charging station scores for the charging station weighted according to user weights corresponding to the identifier. A charger recommendation is sent to the vehicle responsive to the charger request, the charger recommendation including, for each of the one or more charging stations, a location of the charging station and the user-specific charger score corresponding to the charging station.

### TECHNICAL FIELD

Aspects of the disclosure relate to a customer-centric dynamic charging station assessment system.

### BACKGROUND

The increased availability of electric vehicles has increased the amount of charging stations that are required for vehicles to use. Charging stations may have different attributes, such as charger plug type, maximum charge speed, charge to use, availability, reliability, and location.

### SUMMARY

In one or more illustrative examples, a system for customer-centric dynamic charging station assessment includes a storage configured to maintain, for each of a plurality of charging stations, charging station scores indicating ratings of properties of the charging stations, and maintain, for each of a plurality of users, user weights defining a relative weighting of each of the ratings descriptive of user preferences. The system further includes a processor configured to receive a charger request from a vehicle, the charger request including an identifier of a sender of the charger request and a location of the vehicle, identify one or more charging stations in proximity to the location of the vehicle, for each identified charging station, compute a user-specific charger score using the plurality of charging station scores for the charging station weighted according to the user weights corresponding to the identifier, and send a charger recommendation to the vehicle responsive to the charger request, the charger recommendation including, for each of the one or more charging stations, a location of the charging station and the user-specific charger score corresponding to the charging station.

In one or more illustrative examples, a method for customer-centric dynamic charging station assessment includes receiving a charger request from a vehicle, the charger request including an identifier of a sender of the charger request and a location of the vehicle; identifying one or more charging stations in proximity to the location of the vehicle; for each identified charging station, computing a user-specific charger score using a plurality of charging station scores for the charging station weighted according to user weights corresponding to the identifier; and sending a charger recommendation to the vehicle responsive to the charger request, the charger recommendation including, for each of the one or more charging stations, a location of the charging station and the user-specific charger score corresponding to the charging station.

In one or more illustrative examples, non-transitory computer-readable medium includes instructions for customer-centric dynamic charging station assessment that, when executed by one or more computing devices, cause the one or more computing devices to perform operations including to receive a charger request from a vehicle, the charger request including an identifier of a sender of the charger request and a location of the vehicle; identify one or more charging stations in proximity to the location of the vehicle; for each identified charging station, compute a user-specific charger score using a plurality of charging station scores for the charging station weighted according to user weights corresponding to the identifier; and send a charger recommendation to the vehicle responsive to the charger request, the charger recommendation including, for each of the one or more charging stations, a location of the charging station and the user-specific charger score corresponding to the charging station.

### BRIEF DESCRIPTION OF THE DRAWINGS

FIG. 1 illustrates an example system for customer-centric dynamic charging station assessment for vehicles;

FIG. 2 illustrates an example process for determining customer-centric charger recommendations for a vehicle;

FIG. 3 illustrates an example data flow for determining reliability scores for the charging stations;

FIG. 4A illustrates operation of the data pre-processing portion of the data flow of FIG. 3 in a first example;

FIG. 4B illustrates operation of the data pre-processing portion of the data flow of FIG. 3 in a second example;

FIG. 5 illustrates an example charging station reliability score (CSRS) algorithm to generate the reliability scores for the charging stations using;

FIG. 6 illustrates an example process for the assignment of scores to individual charging visits (CV);

FIG. 7 illustrates an example of combination of the reliability score and other scores to determine a user-specific charger score for a charging station;

FIG. 8 illustrates an example human machine interface (HMI) of a navigation view of the vehicle illustrating user-specific charger scores;

FIG. 9 illustrates an example process for customer-centric dynamic charging station assessment for vehicle; and

FIG. 10 illustrates an example computing device for customer-centric dynamic charging station assessment for vehicles.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various w combinations and modifications of the features consistent with the teachings of this disclosure, however, could be desired for particular applications or implementations.

Electric vehicle (EV) public charging and trip planning is relatively complicated compared to internal combustion engine (ICE) vehicle refueling. EV charging takes a longer time than ICE refueling. Due this increased time spend refueling, users may decide on a charging station based on various ratings that may be less relevant for an ICE vehicle. Examples of such ratings may include cleanliness of the facility, available points of interest (POIs), available amenities, competitive price or savings, fast speeds, and/or well-lit conditions at the charging location.

Different users may have different preferences for these various ratings. For example, a first user may prefer to charge the vehicle where the charger has the highest reliability rating. In another example, a second user may prefer to charge the vehicle where POIs are available. As a yet another example, a third user may desire a clean restroom facility nearby.

A charger recommendation system may provide scores for chargers or charger locations for each of a plurality of such ratings. However, such as system may present a user with many different numbers, which may be difficult for the user to distill into a desired choice. An enhanced charger recommendation system may incorporate a learning mechanism to capture user charging behavior. This behavior may be used to determine a per-user weighting of the different ratings. By applying these weights to collected information about the chargers and charger locations, the charger recommendation system may provide a ranking of chargers tailored to the user's requirements and historical behavior.

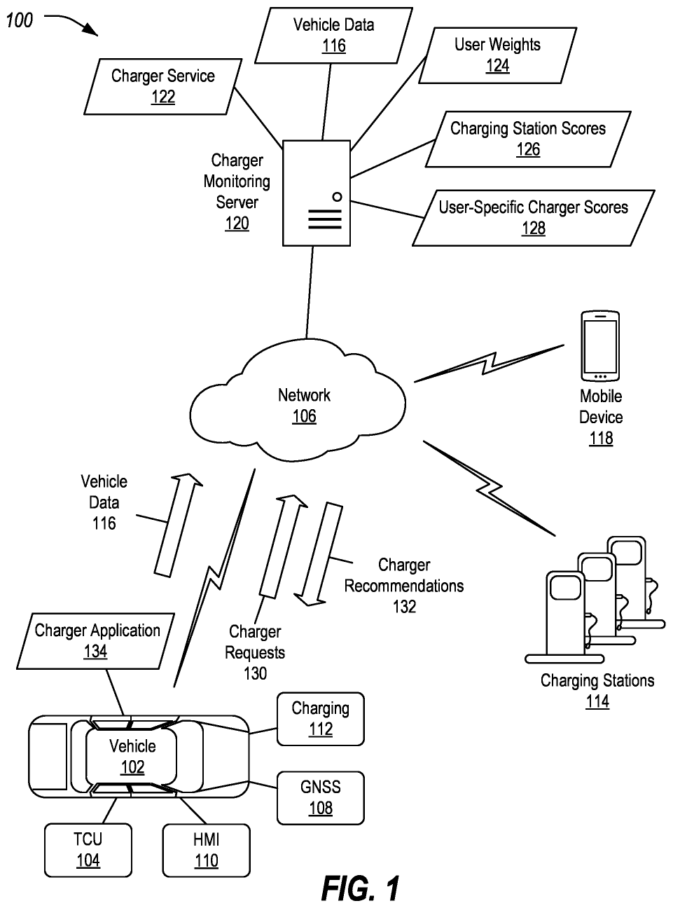

FIG. 1 illustrates an example system 100 for customer-centric dynamic charging station assessment for vehicles 102. The vehicle 102 includes components such as a telematics control unit (TCU) 104, an HMI controller 110, a global navigation satellite system (GNSS) controller 108, and a charging controller 112. The vehicles 102, charging station 114, mobile devices 118, and charger monitoring server 120 may be configured to communicate over a communications network 106. The charger monitoring server 120 may be configured to receive raw vehicle data 116 from the vehicles 102. Using the raw vehicle data 116, a charger service 122 hosted by the charger monitoring server 120 may be configured to generate user weights 124 descriptive of which ratings are weighted more or less heavily in the user's decision to choose a charging station 114. The charger service 122 may also use the raw vehicle data 116 to generate charging station scores 126 descriptive of ratings of the charging stations 114. The user weights 124 and the charging station scores 126 may accordingly be used to provide charger recommendations 132 to users of the vehicles 102, tailored to the user's requirements and historical behavior.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an internal combustion engine, a traction battery, and one or more electric motors. Hybrid vehicles 102 may come in various forms, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs), globally unique identifiers (GUIDs), customer or fleet accounts, etc.

The vehicle 102 may include a plurality of components configured to perform and manage various vehicle 102 functions under the power of the vehicle battery and/or drivetrain. As depicted, the example vehicle components are represented as discrete controllers (e.g., the TCU 104, the HMI controller 110, the GNSS controller 108, the charging controller 112, etc.). However, the components of the vehicle 102 may share physical hardware, firmware, and/or software, such that the functionality from multiple controllers may be integrated into a single controller, and that the functionality of various such controllers may be distributed across a plurality of controllers.

The vehicle 102 may utilize the TCU 104 for communication over the communications network 106. The TCU 104 may include network hardware configured to facilitate communication between the vehicle 102 and other devices of the system 100. For example, the TCU 104 may include or otherwise access a cellular modem configured to facilitate communication with the communications network 106. The communications network 106 may include one or more interconnected communication networks such as the Internet, a cable television distribution network, a satellite link network, a local area network, and a telephone network, as some non-limiting examples.

The GNSS controller 108 may be configured to provide information indicative of the current location of the vehicle 102. In an example, the GNSS controller 108 may be responsible for receiving signals from a GNSS constellation of satellites. This may allow the GNSS controller 108 to receive time information as well as for determining a precise location of the vehicle 102. The location determined by the GNSS controller 108 may be used for various tasks such as navigation or other location-based services.

The HMI controller 110 may be configured to provide an interface through which the vehicle 102 occupants may interact with the vehicle 102. The interface may include a touchscreen display, voice commands, and physical controls such as buttons and knobs. The HMI controller 110 may be configured to receive user input via the various buttons or other controls, as well as provide status information to a driver, such as fuel level information, engine operating temperature information, and current location of the vehicle 102. The HMI controller 110 may be configured to provide information to various displays within the vehicle 102, such as a center stack touchscreen, a gauge cluster screen, etc. The HMI controller 110 may accordingly allow the vehicle 102 occupants to access and control various systems such as navigation, entertainment, and climate control.

The charging controller 112 may be configured to manage the charging of the battery, including monitoring the charging status, managing the flow of electricity, and communicating with the power grid. The charging controller 112 also may include a port for connection to a charging station 114, using a cable or other device that allows the vehicle 102 to be charged from an external power source. The charging stations 114 may be configured to direct and manage the transfer of energy between a power source and the vehicle 102. An external power source may provide direct current (DC) or alternating current (AC) electric power to the charging stations 114. The charging stations 114 may, in turn, have a charge connector for plugging into a respective charge port of the vehicle 102. The charge port may be any type of port configured to transfer power from the charging stations 114 to the vehicle 102. Alternatively, the charging stations 114 may be configured to transfer power using other approaches, such as a wireless inductive coupling. However connected to the charging controller 112, the charging stations 114 may include circuitry and controls to direct and manage the transfer of energy between the power source and the vehicle 102.

The mobile device 118 may be any of various types of portable computing device, such as cellular phones, tablet computers, smart watches, laptop computers, portable music players, or other devices having processing and communications capabilities. The mobile device 118 may include one or more processors configured to execute computer instructions, and a storage medium on which the computer-executable instructions and/or data may be maintained.

The charger monitoring server 120 may be an example of a networked computing device that is accessible to the vehicles 102, mobile devices 118, charging stations 114, and/or other devices over the communications network 106. The vehicle 102 may monitor its charging station 114 usage and may send its raw vehicle data 116 over the communications network 106 to the charger monitoring server 120. In another example, the charger monitoring server 120 may be configured to receive raw vehicle data 116 from the charging stations 114 over the charger monitoring server 120 (e.g., as part of a billing process for charging station 114 usage or as a separate process).

The raw vehicle data 116 may include alerts or other information transmitted from the vehicles 102 to the charger monitoring server 120 in various approaches. In an example, the vehicles 102 may send the raw vehicle data 116 responsive to occurrence of an event, such as a completed charge event, a charger plugged in event, etc. In another example, the vehicles 102 may send the raw vehicle data 116 to the charger services 122 periodically, or nightly, or at another time where network connectivity is available, such as when the vehicle 102 is at a home location and connected to a home network connected instead of to cellular.

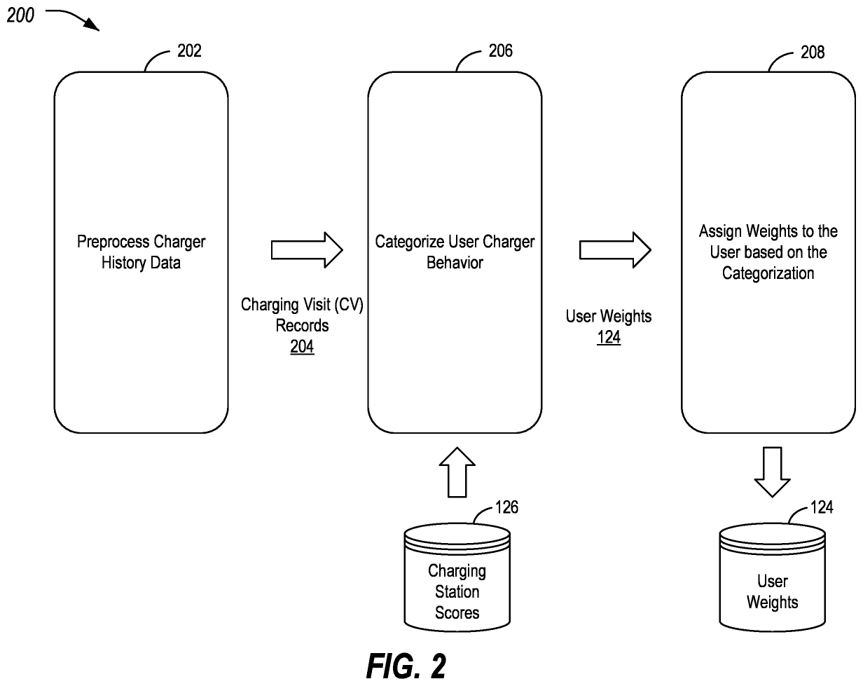

The charger service 122 may be an example of an application executed by the charger monitoring server 120. As explained in further detail herein, the charger service 122 may be configured to perform clustering to determine the user weights 124 from the raw vehicle data 116. The user weights 124 may define the relative weighting of a plurality of ratings that may be used by the user to determine which charging station 114 to use. The plurality of ratings may include aspects such as cleanliness of the facility, available POIs, competitive price, fast charge availability, and/or well-lit conditions. Further aspects of the determination of the user weights 124 are discussed with respect to FIG. 2.

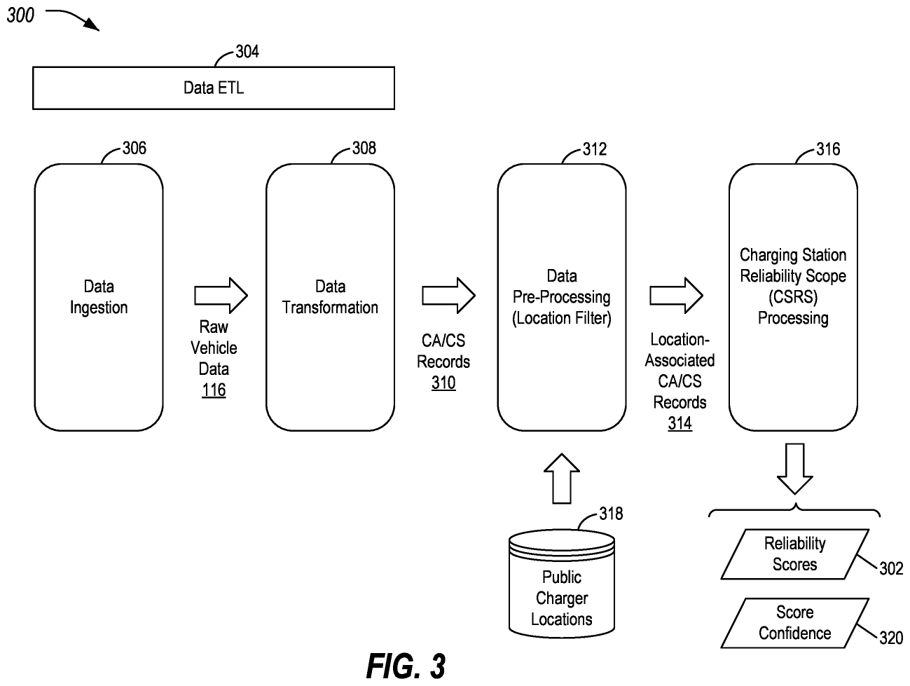

The charger service 122 may be further configured to generate charging station scores 126 based on the raw vehicle data 116. The charging station scores 126 may be generated for the plurality of ratings that are weighted by the user weights 124. Aspects of the generation of the charging station scores 126 are discussed with respect to FIGS. 3-5. It should be noted that in other examples, the charger services 122 may receive at least a portion of the charging station scores 126 from an outside charger rating service. This may allow the charger service 122 to have initial information with respect to the ratings of the charging stations 114.

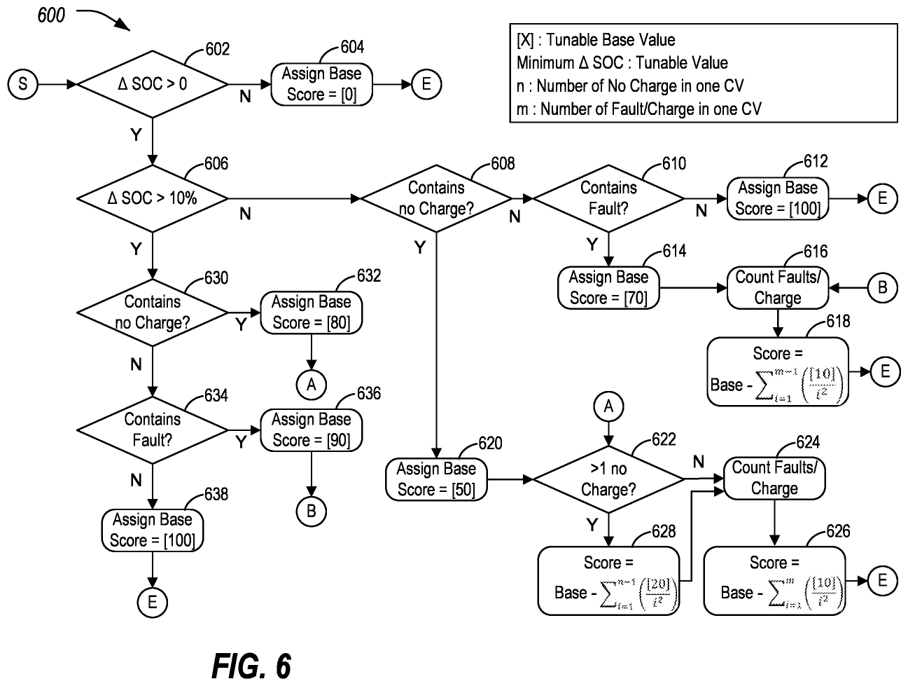

The charger service 122 may be further configured to use those charging station scores 126 and the user weights 124 to determine user-specific charger scores 128 for each of the charging stations 114. In an example, in response to receiving a charger request 130 from a vehicle 102, the charger service 122 may provide charger recommendations 132 including user-specific charger scores 128 tailored to the vehicle 102 requesting to be charged. Aspects of the determination of the user-specific charger scores 128 are discussed with respect to FIG. 6.

A charger application 134 may be installed to the vehicle 102. Using the charger application 134, if the user has opted in, the vehicle 102 may send the raw vehicle data 116 to the charger service 122. Additionally, the user may send a charger request 130 to the charger service 122 to request that one or more charging stations 114 be recommended for charging a vehicle 102. The charger request 130 may include information such as the location of the vehicle 102 and an identifier of the user or of the vehicle 102. Using the raw vehicle data 116, the charger service 122 may determine a charger recommendation 132 for the vehicle 102 tailored to the user weights 124 of the different ratings. The charger application 134 may receive the charger recommendation 132 from the charger service 122 and provide the response to the user.

FIG. 2 illustrates an example process 200 for determining user weights 124 for users of the system 100. In an example, the process 200 may be performed by the charger service 122 executed by the charger monitoring server 120 in the context of the system 100.

At operation 202, the charger service 122 pre-processes the raw vehicle data 116. In an example, the charger service 122 may receive raw vehicle data 116 from vehicles 102 where the users have authorized data collection of their raw vehicle data 116. The charger service 122 may correlate the raw vehicle data 116 into charging visit (CV) records 204. Each CV record 204 may include one or more EV events that occurred within a specific date and time window identified as a visit arrival and departure using the vehicle 102 odometer as a key aggregator criterion. A CV record 204 at a charging station 114 may include several charging attempts (CAs). Each charging attempt may be assigned one of a set of possible states, such as (i) Charged and No Fault; (ii) Charged and Fault; or (iii) No Charge (Fault and No Fault). The CV record 204 may also be correlated with other information, such as a location determined from the GNSS controller 108 of the vehicle 102, and/or the charging station scores 126 indicating the ratings of the charging stations 114 with respect to various aspects.

At operation 206, the charger service 122 uses clustering approaches to categorize the CV record 204 into user behaviors. In an example, the charger service 122 may utilize techniques such as K-means or spatial-temporal filter method to categorize the CV records 204 of the user charging behavior. This may allow the charger service 122 to identify which ratings the users tend to prefer in the charging stations 114 that are used.

K-Means clustering refers to an unsupervised machine learning technique used for grouping a set of n data points into k clusters, where k may be a user-defined parameter. The goal of K-Means clustering may be to partition n data points into k clusters such that the sum of squared distances between the data points and their corresponding cluster centroids may be minimized. The K-Means algorithm works iteratively by first randomly selecting k initial centroids, then assigning each data point to the nearest centroid, and then recomputing the centroid positions based on the mean of the assigned data points.

Spatio-Temporal Clustering refers to a data mining technique used to identify patterns in large datasets that contain both spatial and temporal information. This technique may be commonly used in geographic information systems (GIS), weather forecasting, and traffic analysis, among other applications. The goal of spatio-temporal clustering may be to identify groups of similar events or observations that occur in close proximity to each other in both space and time.

A difference between Spatio-Temporal Clustering and K-Means Clustering may be that Spatio-Temporal Clustering takes into account both spatial and temporal information, while K-Means Clustering only considers the data points' attributes and does not consider the spatial and temporal information. Spatio-Temporal Clustering may be often used for geospatial data analysis, while K-Means Clustering may be used for more general data analysis.

Spatio-Temporal Clustering and K-Means Clustering may be used to analyze user interactions with the charging stations 114 in order to identify users' preferences. For example, these techniques may be used on the CV records 204, which may include the user's location, the time of the charging interaction, and information related to the charging station 114 that was accessed (e.g., whether there are nearby POIs, charging speeds that are available, etc.). By applying either Spatio-Temporal Clustering or K-Means Clustering to the CV records 204, the charger service 122 may identify groups of users who exhibit similar patterns of interaction, such as users who frequently interact with charging stations 114 nearby POIs, or users who prefer chargers in well-lit areas at night.

It should be noted that these are merely examples, and other unsupervised clustering techniques may be used instead of or in addition to Spatio-Temporal Clustering and K-Means Clustering, such as gaussian mixture models (GMM) or density-based spatial clustering of applications with noise (DBSCAN).

At operation 208, the charger service 122 assigns user weights 124 to each ratings for the user based on the clustering. Examples of such user weights 124 may be applied to ratings for various factors, such as cleanliness of the facility, available POIs, available amenities, competitive price or savings, fast speeds, and/or well-lit conditions at the charging location.

For instance, a first user may prefer to charge at charging stations 114 with a high reliability rating. This user may receive a higher user weight 124 for reliability as compared to the other ratings. A second user may prefer to charge at charging stations 114 may prefer to charge at locations where good POIs are nearby (e.g., with a high POI rating). This user may receive a higher user weight 124 for POIs as compared to the other ratings. A third user may prefer to charger where a clean restroom is identified in the service center (e.g., prefers a higher convenience rating). This user may be assigned a higher amenities user weight 124. A fourth user may prefer free charging options, so a user weight 124 may be assigned to this user to give greater preference to such charging stations 114. In some examples, the total of each of the user weights 124 may be normalized to total one.

FIG. 3 illustrates an example data flow 300 for determining reliability scores 302 for the charging stations 114. The data flow 300 for determining the reliability scores 302 includes three aspects: data extract, transform, and load (ETL) 304 (including data ingestion 306 and data transformation 308), data pre-processing 312, and CSRS processing 316.

In general, the reliability scores 302 may be determined using the raw vehicle data 116. The reliability scores 302 may be based on previous customer charging success or lack of success rates. Charging locations with lower scores may require more charge attempts or require manual intervention to begin a charging session. Very low scores may indicate that the vehicle 102 were unable to charge at the charging station 114.

The data ETL 304 may be an initial portion of the data flow 300. The data ingestion 306 portion of the data ETL 304 may receive the raw vehicle data 116 from the vehicles 102 into the cloud environment of the charger monitoring server 120. This data may be received from those vehicles 102 having signed up to send raw vehicle data 116 to the charger service 122. In an example, the vehicles 102 may send alerts-drive charging record data based on vehicle 102 activity at the charging stations 114. This alert driven messaging may include, for example various actions performed by the vehicle 102, including vehicle start, vehicle stop, vehicle charger plug in, vehicle begin charge, vehicle end charge, vehicle charger unplug, etc.

The data transformation 308 portion of the data ETL 304 may convert the ingested raw vehicle data 116 into to charging attempts-based data. For example, the data transformation 308 may correlate the events in the raw vehicle data 116 into charging attempts. For instance, each charging attempt record may include one or more EV events that occurred between plug in to the charging station 114 and disconnection from the charging station 114. These EV events may include whether charging was initiated, whether charging was completed, whether charging was interrupted, initial state of charge (SOC), ending SOC, etc. Each charging attempt record may be assigned a charging status. This status may be one of: charged and no fault, charged and fault, no charge and no fault, and no charge and fault. Thus, the data transformation 308 may correlate the raw vehicle data 116 records into discrete charging attempts each with a defined charging status. These records may be referred to as charge-attempt charging-status (CACS) records 310.

The data pre-processing 312 portion of the data flow 300 may be used to filter the CACS records 310 to include only public chargers that are available for use by users in general. For example, it may be undesirable to recommend a charging station 114 located on private property to which the user may not have access. These filtered CACS records 310 may be referred to as location-associated CACS records 314.

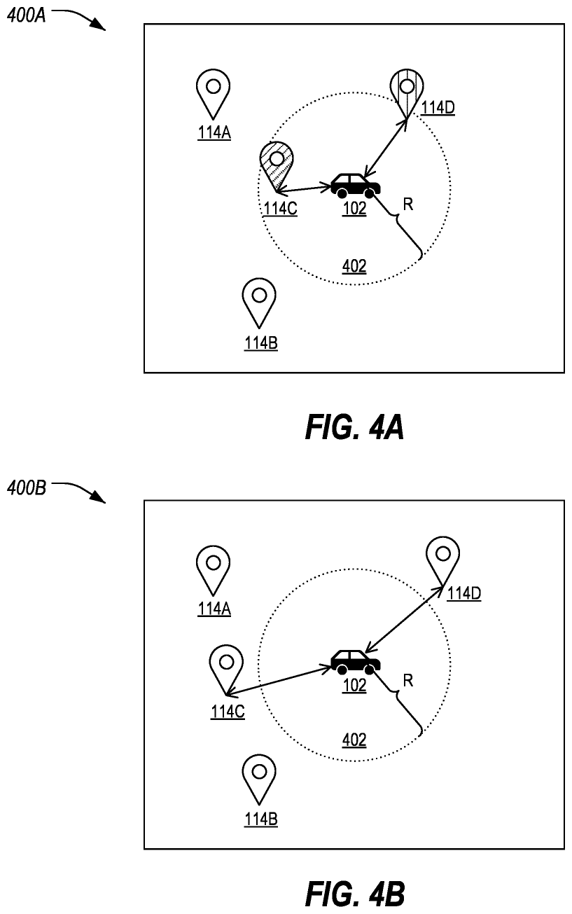

FIGS. 4A-4B collectively illustrate operation of the data pre-processing 312 portion of the data flow 300. As shown in both the example 400A of FIG. 4A and in the example 400B of FIG. 4B, a plurality of charging stations 114 are plotted at their relative locations with respect to a vehicle 102.

Referring to FIGS. 4A-4B, and with continuing reference to FIG. 3, the location of the vehicle 102 may be determined using the GNSS controller 108 of the vehicle 102. The relative locations of charging stations 114 may be determined based on a public charger locations database 318. The public charger locations database 318 may include a listing of the charging station 114 indexed by geographic location. For example, each charging station 114 may be identified in the public charger locations database 318 according to latitude and longitude, in an example. The public charger locations database 318 may be maintained by or otherwise made accessible to the charger monitoring server 120.

A radius R may define a threshold 402 within which one of the charging stations 114 is to be located to be considered to be the location at which the vehicle 102 is being charged. The specific distance R may be set empirically, based on ratings such as the accuracy of the GNSS location determined by the vehicle 102, the accuracy of the location data for the charging stations 114, etc.

Referring to FIG. 4A, four charging stations 114 are illustrated (charging station 114A, charging station 114B, charging station 114C, and charging station 114D). Charging stations 114A and 114B are located outside of the threshold 402, while charging stations 114C and 114D are located within the threshold 402. As the charging station 114C is closer to the vehicle 102 than the charging station 114D, in this example the vehicle 102 may be associated with charging station 114C. Thus, this CACS record 310 may be associated with the charging station 114C as a location-associated CACS record 314. If only a single charging station 114 was located within the threshold 402, then the vehicle 102 would be associated with that charging station 114.

Referring to FIG. 4B, four charging stations 114 are illustrated (charging station 114A, charging station 114B, charging station 114C, and charging station 114D). Charging stations 114A, 114B, 114C, and 114D are each located outside of the threshold 402. As none of the known public charging stations 114 are located within the threshold 402, in the example 400B it may be inferred that the vehicle 102 was charging at a private charger. Thus, this CACS record 310 may be excluded from the location-associated CACS records 314.

Referring back to FIG. 3, the data pre-processing 312 may accordingly filter the CACS records 310 to only continue to process the location-associated CACS records 314. This may allow the charger service 122 to steer clear of suggesting private charging stations 114 to users who may lack access to such charging stations 114.

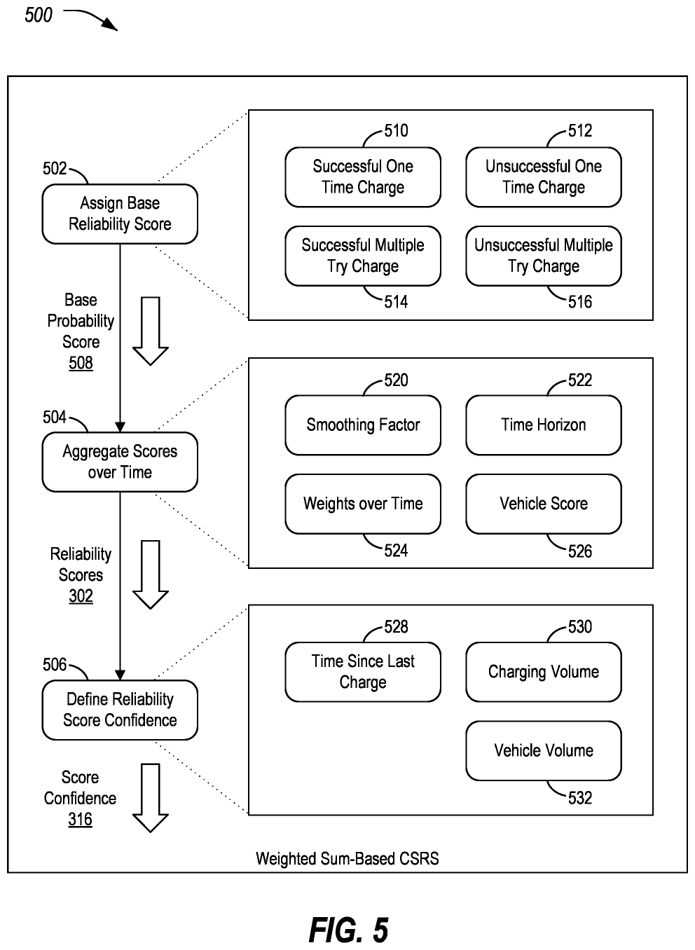

Referring to FIG. 5, and with continuing reference to FIG. 3, the CSRS processing 316 may be configured to utilize a CSRS algorithm to generate the reliability scores 302 for the charging stations 114 using the filtered CACS records 310 that are associated with the charging stations 114. As shown in FIG. 5, the CSRS algorithm may include an assign reliability score operation 502, an aggregate reliability score operation 504, and an define reliability score confidence operation 506.

The assign reliability score operation 502 may include assigning a base probability score 508 for reliability of each charging station 114 based on the CACS records 310 showing success or lack of success of the charging station 114. The assign reliability score operation 502 may also consider penalizing the base probability score 508 considering severity of issues with the charging station 114. An example of possible ratings to use in computing the base probability score 508 may include a count of successful one-time charge attempts 510, a count of unsuccessful one-time charge attempts 512, a count of successful multiple-try charge attempts 514, and/or a count of unsuccessful multiple-time charge attempts 516.

FIG. 6 illustrates an example process 600 for the assignment of the base probability score 508 to individual CVs. The process 600 may be performed per record, using the location-associated CACS records 314.

At operation 602, the CSRS algorithm determines whether the change in SOC indicated in the location-associated CACS record 314 is greater than zero. If not, no charging was accomplished and at operation 604 a base probability score 508 of zero may be assigned to the CACS records 310. After operation 604, the process 600 ends.

If the change in SOC at operation 602 is greater than zero, control passes to operation 606 to determine whether the change in SOC is greater than 10%. If not, control passes to operation 608.

At operation 608, the CSRS algorithm determines whether the CACS record 314 includes any no charge events. If zero such no charge events are found, control proceeds to operation 610 to further determine whether any fault events are included in the CACS record 314. If no fault events are found either, then at operation 612 a base probability score 508 of one hundred is assigned to the CACS record 314. After operation 612, the process 600 ends.

If fault events are found at operation 610, control proceeds to operation 614, where a base probability score 508 of seventy is assigned to the CACS record 314. Control then proceeds to operation 616, in which the quantity of fault and charge records (herein referred to as m) in the CACS record 314 are counted. At operation 618, the base probability score 508 may be adjusted based on m using equation (1):

$$Score = Base - {\sum }_{i = 1}^{m - 1} ( \frac{[ 10 ]}{{i}^{2}} ) \qquad ( 1 )$$

### Where:

m is the quantity of faults and charge tuples; and
i is the individual attempt within the CACS records 314.

After operation 618, the process 600 ends.

Referring back to the yes branch of operation 608, if one or more no charge events are found, control passes to operation 620, where a base probability score 508 of fifty is assigned. Next, at operation 622, the CSRS algorithm determines whether the CACS record 314 includes more than one no charge event. If not, control passes to operation 624, in which the quantity of faults and charge (herein referred to as m) in the CACS record 314 are counted. At operation 626, the base probability score 508 may be adjusted based on m using equation (2), similar to equation (1):

$$Score = Base - {\sum }_{i = 1}^{m} ( \frac{[ 10 ]}{{i}^{2}} ) \qquad ( 2 )$$

After operation 626, the process 600 ends.

If at operation 622, the CSRS algorithm determines that the CACS record 314 includes more than one no charge event, control instead proceeds to operation 628. At operation 628, the base score may be adjusted based on n using equation (3), as follows:

$$Score = Base - {\sum }_{i = 1}^{n} ( \frac{[ 20 ]}{{i}^{2}} ) \qquad ( 3 )$$

Where:
n is the quantity of no charge events in the CACS record 314.

After operation 628, the process proceeds to operation 624 to further account for faults.

Referring back to operation 606, where if the change in SOC is greater than 10%, control passes to operation 630. At operation 630, the CSRS algorithm determines whether the CACS record 314 includes any no charge events. If any such no charge events are found, control proceeds to operation 632 to assign the base probability score 508 to eighty. After operation 632, control proceeds to operation 622, discussed above.

If no such events are found at operation 630, control proceeds to operation 634 to determine whether any fault events are included in the CACS record 314. If any fault events are found, then control proceeds to operation 636 to assign a base probability score 508 of ninety. After operation 636, control proceeds to operation 616, discussed above.

If no such faults are found at operation 634, control proceeds to operation 638 to assign a base probability score 508 of one hundred. After operation 638, the process 600 ends.

It should be noted that many of the values discussed with respect to the process 600 are configurable. For instance, the base values indicated in FIG. 6 and herein as within square brackets are tunable and may be adjusted. Additionally the change in SOC values discussed herein may also be tunable.

As a specific example, a user may utilize a charging station 114 and may take three attempts to receive the charge. This may be indicated in the CV records 204 as [No Charge, No Charge, Fault/Charged]. Analysis of this record may proceed from operation 602 to operation 606, to operation 632 (to a base of eighty), to operation 622 to discount the base to sixty at operation 628.

As another specific example, a user may utilize a charging station 114 and may take five attempts to receive the charge. This may be indicated in the CV records 204 as [No Charge, No Charge, Fault/Charged, Fault/Charged, No Fault/Charged]. Analysis of this record may proceed from operation 602 to operation 606, to operation 632 (to a base of eighty), to operation 622 to discount the base to sixty at operation 628, to operation 624 to operation 626 to further discount the base to 47.5.

Referring back to FIG. 5, the aggregate reliability score operation 504 may include aggregating the base probability score 508 over time. For instance, an exponential moving average (EMA) may be used to aggregate the base probability scores 508 over time to obtain a more accurate and stable estimate of the reliability of the charging stations 114. The EMA may give more weight to recent data and less weight to older data, which can help to smooth out fluctuations in the base probability scores 508 and provide a more stable estimate over time. This estimate over time may be referred to herein as the reliability scores 302.

For example, the EMA may be computed using equation (4):

$${\hat{S}}_{D + 1 \vert D} = \frac{{\sum }_{d = 0}^{D} {\sum }_{i = 1}^{{n}_{d}} ( {( 1 - α )}^{d} + {c}_{i j} ) {S}_{i}}{{\sum }_{d = 0}^{D} ( {( 1 - α )}^{d} + {c}_{i , j} ) {n}_{d}} \qquad ( 4 )$$

### Where:

S refers to the reliability score 302;
i refers to the index of the CACS record 314;
j refers to the specific vehicle 102;
D refers to the range of history days to be considered specified by a time horizon 522 used to limit the window of time from which the reliability score 302 may be computed;
d refers to the day;
α refers to a smoothing factor 520 between 0 and 1;
n_{d} refers to the number of charging visits on day d; and
c_{i,j} refers to a vehicle score 526 for vehicle j.

The vehicle score 526 may reflect that some vehicles 102 may be weighted more heavily in the determination of the reliability scores 302 as compared to other vehicles 102. As a possibility, a vehicle 102 with more uses of the charging stations 114 in the location-associated CACS records 314 may be weighted more heavily in the aggregate reliability score operation 504 than vehicles 102 with fewer uses of the charging stations 114.

The EMA weights 524 over time may be used to provide variations on the weighting of earlier EMA values. For example, instead of using the same smoothing factor for each iteration, different EMA weights 524 may be used for different recencies of EMA values.

As a more complete example, scores may be aggregated over an example period of eight days to generate a reliability score 302. For example, consider the following scores, which may be computed as shown in FIG. 6:

| Day | Day | Day | Day | Day | Day | Day | Day |
|---|---|---|---|---|---|---|---|
| 1 | 2 | 3 | 4 | 5 | 6 | 7 | 8 |
| 90 | 90 | 90 | N/A | N/A | 40 | 100 | 40 |
| 100 | 100 | 100 | | | 50 | | |
| 90 | | | | | 90 | | |
| 100 | | | | | 90 | | |

A total number of events for each day may be defined as follows:

| | | | | | | | |
|---|---|---|---|---|---|---|---|
| 4 | 2 | 2 | 0 | 0 | 4 | 1 | 1 |

EMA weights 524 may be defined for each day as follows, in an example with a smoothing factor 520 of 0.2:

| | | | | | | | |
|---|---|---|---|---|---|---|---|
| (1 − | (1 − | (1 − | (1 − | (1 − | (1 − | (1 − | (1 − |
| 0.2)⁷ | 0.2)⁶ | 0.2)⁵ | 0.2)⁴ | 0.2)³ | 0.2)² | 0.2)¹ | 0.2)⁰ |

Which may be computed as:

| | | | | | | | |
|---|---|---|---|---|---|---|---|
| 0.2097152 | 0.262144 | 0.3276 | 0.4096 | 0.512 | 0.64 | 0.8 | 1 |

Summing each day's scores and multiplying by the associated EMA weight 524 provides the following weighted sums (e.g., computed such that Σᵢ₌₁ⁿ Sᵢ*(1−α)^{ΔD}):

| | | | | | | | |
|---|---|---|---|---|---|---|---|
| 79.6917 | 49.80736 | 62.244 | 0 | 0 | 172.8 | 80 | 40 |

Sums of weights for each day may also be computed as the total events times the weights as follows (e.g., as Σᵢ₌₁ⁿ Sᵢ*(1−α)^{ΔD}):

| | | | | | | | |
|---|---|---|---|---|---|---|---|
| 0.8388 | 0.5242 | 0.6552 | 0 | 0 | 2.56 | 0.8 | 1 |

The total sum of weights may therefore be 6.3782, and the total sum of the weighted sum may be 484.54306, which once divided, yields an aggregate charging station score 126 of 75.96 for the charging station 114 across the right day period.

It should be noted that other approaches to the determination of reliability scores 302 may be used. In another example, instead of use of EMA, the reliability scores 302 may be calculated as an exponentially decaying probability function dependent on operational lifecycle of the charging stations 114. Since the rate may not remain constant over the operational lifecycle of a component, the average time-based quantities can also be used to calculate reliability.

The adjust reliability score confidence operation 506 may be used to determine a confidence 320 of the reliability scores 302. Various aspects may be used to determine the confidence 320, such as a time since last charge 528 (the last use of the charging station 114), charging volume 530 (the quantity of uses of the charging station 114), and the vehicle volume 532 (e.g., the distribution of unique users of the charging station 114, and/or a minimum quantity of uses of the charging station 114).

For example, if the last use of the charging station 114 was recent, and the quantity of uses of the charging station 114 exceeds a predefined usage threshold, then the reliability score 302 for that charging station 114 may be assigned a higher confidence 320. On the other hand, if the last use of the charging station 114 was a longer than a predefined period of time ago (e.g., no uses in the current EMA iteration or uses below the predefined usage threshold) then charging station 114 may be assigned a lower confidence 320 in the reliability score 302.

To take the distribution of unique uses of the charging station 114 into account, the standard deviation of the unique uses may be calculated and used to adjust the confidence 320 of the reliability score 302. A higher standard deviation might indicate that the charging station 114 is being used by a wide variety of users with different experiences, which might lead to lower score confidence 320 in the reliability score 302.

In another example, a minimum quantity of uses of the charging station 114 may be used to determine the minimum confidence 320 for the reliability scores 302. For example, a minimum of two, or fifty, or one hundred uses of the charging station 114 may be required before the reliability score 302 may be considered reliable. Thus, in an example, no confidence 320 may be provided for charging stations 114 that have yet to be used minimum quantity of uses within the location-associated CACS records 314.

By considering these and other ratings, the confidence 320 of the reliability scores 302 may be determined to allow more informed decisions about the reliability and performance of the charging stations 114 to be performed.

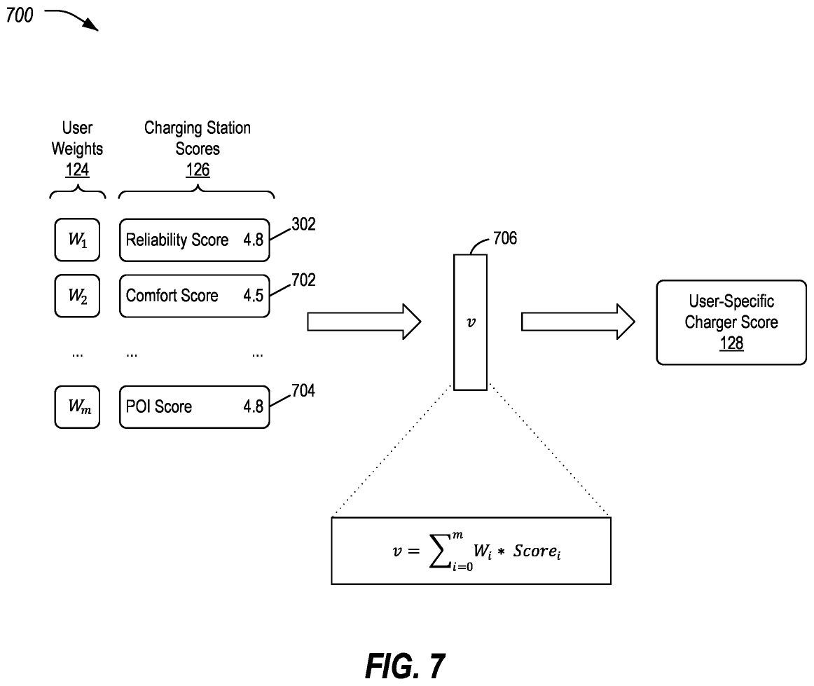

FIG. 7 illustrates an example of combination of the reliability score 302 and other scores to determine a user-specific charger score 128 for a charging station 114. As shown, charging station scores 126 such as the reliability score 302, a comfort score 702, and a POI score 704 may be supplied as inputs to a vector model 706. The vector model 706 may additionally be supplied with user weights 124 corresponding to each of the charging station scores 126.

The vector model 706 may be used to convert the separate charging station scores 126 and the user weights 124 into a single user-specific charger score 128. In a simple example, equation (4) may be used to perform the combination:

$$v = {\sum }_{i = 0}^{m} {W}_{i} * {Score}_{i} \qquad ( 4 )$$

where:
i is the number of the charging station score 126 to be included;
m is the total quantity of charging station scores 126;
Score; is the i-th charging station score 126 to be included;
Wᵢ is the i-th user weight 124 corresponding to the i-th charging station score 126 (which may be normalized such that the Σᵢ₌₀^{m} Wᵢ equals 1); and
ν is the user-specific charger score 128.

In an example, assuming the reliability score 302 is 4.8, the comfort score 702 is 4.5, and the POI score 704 is 4.8, and further assuming the reliability user weight 124 is 0.8, the comfort user weight 124 is 0.1, and the POI user weight 124 is 0.1, the user-specific charger score 128 may be:

$$( 4.8 * 0.8 ) + ( 4.5 * 0.1 ) + ( 4.8 * 0.1 ) = 4.77$$

Significantly, the same charging station 114 may have a different user-specific charger score 128 for a different user with different user weights 124.

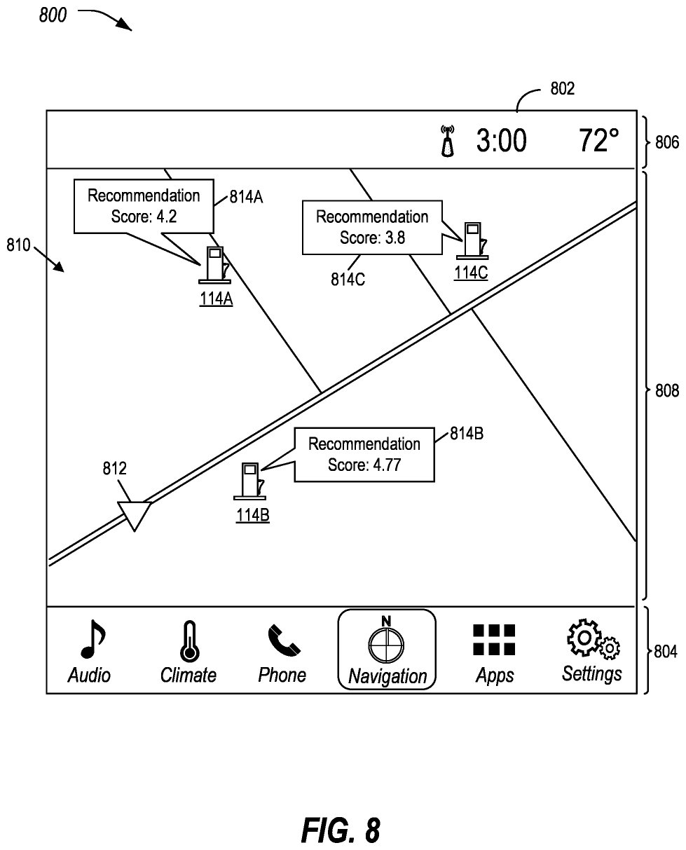

FIG. 8 illustrates an example HMI 800 of a navigation view of the vehicle 102. In an example, the HMI 800 may be displayed by the HMI controller 110 on a head unit or other screen 802 of the vehicle 102. The illustrated HMI 800 includes a category listing 804 of one or more screens of content to be displayed in a main screen area 808. As some examples, the category listing 804 may include an audio screen from which configuration of vehicle 102 audio settings may be performed, a climate control screen from which vehicle 102 climate control settings may be configured, a phone screen from which calling services may be utilized, a navigation screen (which is selected) from which maps and routing may be performed, an applications screen from which installed applications may be invoked, and a settings screen from which backlighting or other general settings may be accessed. The HMI 800 may also include a general information area 806 from which time, current temperature, and other information may remain visible to the user, regardless of the specific screen or application that is active in the main screen area 808.

In the navigation mode, the main screen area 808 illustrates a map 810 of the surroundings of the vehicle 102. The location of the vehicle 102 itself is shown as vehicle indication 812. Moreover, as the user is seeking a charging station 114, the map 810 further illustrates the locations of a plurality of available chargers charging stations 114. For each charging station 114, a callout 814 is provided including the user-specific charger score 128 for that respective charging station 114. The user-specific charger scores 128 may serve to inform the user of the desirability of the charging station 114 in terms of the user's specific requirements. For instance, for the charging station 114A, a callout 814A shows a recommendation score of 4.2, for the charging station 114B, a callout 814B shows a recommendation score of 4.88, and for the charging station 114C, a callout 814C shows a recommendation score of 3.8. Each of these scores may be calculated as discussed above (e.g., the recommendation score for the charging station 114B may have been computed as shown in FIG. 8).

FIG. 8 illustrates an example process 900 for customer-centric dynamic charging station 114 assessment for vehicles 102. In an example, the process 900 may be performed by the charger service 122 executed by the charger monitoring server 120, in the context of the system 100. In an example, the charger service 122 may cause the charger monitoring server 120 to maintain, for each of a plurality of charging stations 114, charging station scores 126 indicating ratings of properties of the charging stations 114, and maintain, for each of a plurality of users, user weights 124 defining a relative weighting of each of the ratings descriptive of user preferences.

At operation 902, the charger service 122 determines whether to update the user weights 124 and/or the charging station scores 126 based on the receipt of new raw vehicle data 116 is received. In an example, the vehicles 102 may monitor its charging station 114 usage and may send its raw vehicle data 116 over the communications network 106 to the charger monitoring server 120. In another example, the charger monitoring server 120 may be configured to receive raw vehicle data 116 from the charging stations 114 over the charger monitoring server 120 (e.g., as part of a billing process for charging station 114 usage or as a separate process). In some examples, the charger service 122 may perform updates to the user weights 124 and/or the charging station scores 126 responsive to receipt of new raw vehicle data 116. In other examples, the charger service 122 may perform updates to the user weights 124 and/or the charging station scores 126 periodically, such as daily or weekly. If an update is indicated, control passes to operation 904. If not, control proceed to operation 908.

At operation 904, the charger service 122 updates the user weights 124. In an example, the charger service 122 may correlate the CAs in the raw vehicle data 116 into CV records 204, and may use clustering approaches such as K-means or spatial-temporal filtering to categorize the CV record 204 into user behaviors. The charger service 122 may then assign user weights 124 to each of a plurality of ratings based on the clustering. Examples of such ratings may include cleanliness of the facility, available POIs, available amenities, competitive price or savings, fast speeds, and/or well-lit conditions at the charging location. Further aspects of the computation of user weights 124 are discussed above with respect to FIG. 2.

At operation 906, the charger service 122 updates the charging station scores 126. In an example, the charger service 122 may utilize the raw vehicle data 116 to computer various charging station scores 126 such as the reliability scores 302 discussed in detail with respect to FIGS. 3-6. In other examples, the charger service 122 may updates other charging station scores 126 based on the vehicle data 116, such as cleanliness of the facility, available POIs, available amenities, competitive price or savings, fast speeds, and/or well-lit conditions at the charging location.

At operation 908, the charger service 122 determines whether a charger request 130 is received. In an example, using the charger application 134 executed by a vehicle 102, the user may send a charger request 130 to the charger service 122 to request that one or more charging stations 114 be recommended for charging a vehicle 102. The charger request 130 may include information such as an identifier of the vehicle 102 or an identifier of the user. The charger request 130 may also include a location of the vehicle 102. If a charger request 130 is received, control passes to operation 910. Otherwise, control returns to operation 902.

At operation 910, the charger service 122 identifies the charging stations 114 in proximity to the vehicle 102. In an example, the vehicle 102 sending the charger request 130 may include a location of the vehicle 102 in the charger request 130. This location may be determined using the GNSS controller 108 of the vehicle 102, for instance. The charger service 122 may retrieve this location from the charger request 130 and may query the public charger locations database 318 for charging station 114 within a predefine vicinity to the vehicle 102.

At operation 912, the charger service 122 retrieves the user weights 124 corresponding to the user. In an example, the vehicle 102 sending the charger request 130 may include an identifier of the user and/or of the vehicle 102 in the charger request 130. The charger service 122 may retrieve this identifier from the charger request 130 and may query the stored user weights 124 to identify whether such weights are available for the user. If so, control proceeds to operation 914. If not, control proceeds to operation 916.

At operation 914, the charger service 122 generate user-specific charger scores 128 for each of the charging stations 114 identified at operation 910. For instance, as shown in FIG. 6, the charger service 122 utilizes a weighted sum algorithm to summarize and return a final rating for each charging station 114 using the charging station scores 126 corresponding to each charging station 114 and the user weights 124 retrieved at operation 912. The locations of the charging stations 114 and the associated user-specific charger scores 128 may be added to the charger recommendation 132. Notably, these user-specific charger scores 128 are dynamic, as different users with different user weights 124 may see different ratings for the same charging station 114. After operation 914, control proceeds to operation 918.

At operation 916, instead of generating user-specific charger scores 128, the charger service 122 may default to generating a listing of the charging station scores 126 corresponding to each charging station 114. The locations of the charging stations 114 and the associated charging station scores 126 may be added to the charger recommendation 132. While this information is not specific to the user and is not a single score for each charging station 114, the information still may be useful for the user even if the user-specific charger scores 128 cannot be generated. After operation 916, control proceeds to operation 918.

At operation 918, the charger service 122 provides the charger recommendation 132 to the vehicle 102. The information in the charger recommendation 132 may thereby be displayed to the user. An example of such a display including user-specific charger scores 128 is shown in FIG. 7. After operation 918, control returns to operation 902. While not shown in the FIGS, if the user-specific charger scores 128 are not included in the charger recommendation 132, then the callouts 814 may instead show the plurality of charging station scores 126 for each ratings, instead of the single user-specific charger scores 128 accounting for the user's preferences.

Variations on the process 900 are possible. For example, while the process 900 is shown as a single continuous loop, the process 900 may be divided into a first process for performing the updating of the user weights 124 and the charging station scores 126, and a second process for handling the charger requests 130.

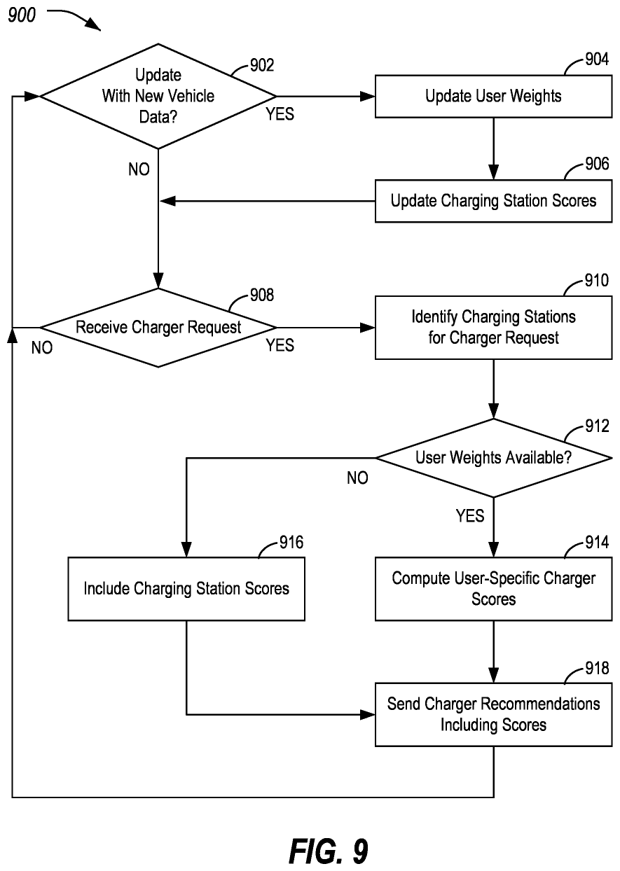

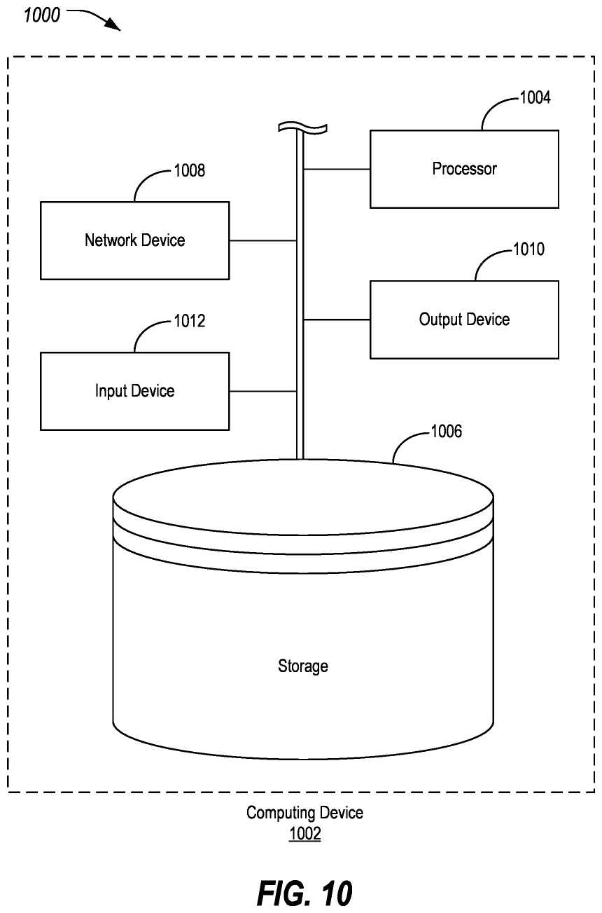

FIG. 10 illustrates an example computing device 1002 for customer-centric dynamic charging station assessment for vehicles. Referring to FIG. 10, and with reference to FIGS. 1-9, the vehicles 102, TCUs 104, communications network 106, GNSS controller 108, HMI controller 110, charging controller 112, charging stations 114, mobile devices 118, and charger monitoring server 120 may include examples of such computing devices 1002. Computing devices 1002 generally include computer-executable instructions, such as those of the charger service 122 and charger application 134, where the instructions may be executable by one or more computing devices 1002. Computer-executable instructions may be compiled or interpreted from computer programs created using a variety of programming languages and/or technologies, including, without limitation, and either alone or in combination, Java™, C, C++, C #, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the raw vehicle data 116, the user weights 124, the user-specific charger scores 128, the charger request 130, and the charger recommendations 132, may be stored and transmitted using a variety of computer-readable media.

As shown, the computing device 1002 may include a processor 1004 that is operatively connected to a storage 1006, a network device 1008, an output device 1010, and an input device 1012. It should be noted that this is merely an example, and computing devices 1002 with more, fewer, or different components may be used.

The processor 1004 may include one or more integrated circuits that implement the functionality of a central processing unit (CPU) and/or graphics processing unit (GPU). In some examples, the processors 1004 are a system on a chip (SoC) that integrates the functionality of the CPU and GPU. The SoC may optionally include other components such as, for example, the storage 1006 and the network device 1008 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1004 executes stored program instructions that are retrieved from the storage 1006. The stored program instructions, accordingly, include software that controls the operation of the processors 1004 to perform the operations described herein. The storage 1006 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 1010. The output device 1010 may include a graphical or visual display device, such as an electronic display screen, projector, printer, or any other suitable device that reproduces a graphical display. As another example, the output device 1010 may include an audio device, such as a loudspeaker or headphone. As yet a further example, the output device 1010 may include a tactile device, such as a mechanically raiseable device that may, in an example, be configured to display braille or another physical output that may be touched to provide information to a user.

The input device 1012 may include any of various devices that enable the computing device 1002 to receive control input from users. Examples of suitable input devices 1012 that receive human interface inputs may include keyboards, mice, trackballs, touchscreens, microphones, graphics tablets, and the like.

The network devices 1008 may each include any of various devices that enable the described components to send and/or receive data from external devices over networks. Examples of suitable network devices 1008 include an Ethernet interface, a Wi-Fi transceiver, a cellular transceiver, or a BLUETOOTH or Bluetooth Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A system for customer-centric dynamic charging station assessment, comprising:
a storage configured to
maintain, for each of a plurality of charging stations, charging station scores indicating ratings of properties of the charging stations, and
maintain, for each of a plurality of users, user weights defining a relative weighting of each of the ratings descriptive of user preferences; and
a processor, configured to
receive a charger request from a vehicle, the charger request including an identifier of a sender of the charger request and a location of the vehicle,
identify one or more charging stations in proximity to the location of the vehicle,
for each identified charging station, compute a user-specific charger score using the plurality of charging station scores for the charging station weighted according to the user weights corresponding to the identifier, and
send a charger recommendation to the vehicle responsive to the charger request, the charger recommendation including, for each of the one or more charging stations, a location of the charging station and the user-specific charger score corresponding to the charging station.

2. The system of claim 1, wherein the processor is further configured to:
receive vehicle data from a plurality of vehicles, the vehicle data being descriptive of charging events of the plurality of vehicles at the plurality of charging stations;
aggregate the vehicle data into charger visits (CV) records according to benchmark information included in the vehicle data;
perform clustering of CV records in view of the ratings of the properties to categorize the vehicle data into user behaviors; and
determine the user weights according to the clustering.

3. The system of claim 2, wherein the clustering is performed using one or more unsupervised clustering techniques.

4. The system of claim 2, wherein the benchmark information is vehicle odometer information.

5. The system of claim 2, wherein the processor is further configured to:
correlate the vehicle data into charge-attempt charging-status (CACS) records descriptive of whether charge attempts defined by the vehicle data were successful or unsuccessful, and whether the charge attempts were single-attempt or multiple-attempt;
assign reliability scores to the charging stations based on the CACS records; and
update the ratings of properties of the charging stations to include the reliability scores based on the vehicle data.

6. The system of claim 5, wherein the processor is further configured to utilize an exponential moving average (EMA) to aggregate the reliability scores over time to obtain a more accurate and stable estimate of reliability.

7. The system of claim 5, wherein the processor is further configured to calculate the reliability scores as an exponentially decaying probability function dependent on operational lifecycle of the charging stations.

8. The system of claim 5, wherein the processor is further configured to filter the CACS records using a public charger locations database to include only those charging stations identified by the public charger locations database.

9. The system of claim 8, where the filtering includes to assign each CACS record of the CACS records to a closest charging station in the public charger locations database that is within a predefined threshold radius from a location specified by the CACS record.

10. The system of claim 1, wherein ratings include cleanliness of the charging stations, available points of interests (POIs), competitive price, fast charge availability, and/or well-lit conditions.

11. A method for customer-centric dynamic charging station assessment, comprising:
receiving a charger request from a vehicle, the charger request including an identifier of a sender of the charger request and a location of the vehicle;
identifying one or more charging stations in proximity to the location of the vehicle;
for each identified charging station, computing a user-specific charger score using a plurality of charging station scores for the charging station weighted according to user weights corresponding to the identifier; and
sending a charger recommendation to the vehicle responsive to the charger request, the charger recommendation including, for each of the one or more charging stations, a location of the charging station and the user-specific charger score corresponding to the charging station.

12. The method of claim 11, further comprising:
receiving vehicle data from a plurality of vehicles, the vehicle data being descriptive of charging events of the plurality of vehicles at a plurality of charging stations;
aggregating the vehicle data into charger visits (CV) records according to benchmark information included in the vehicle data;
performing clustering of CV records in view of ratings of properties of the charging stations to categorize the vehicle data into user behaviors; and
determining the user weights according to the clustering.

13. The method of claim 12, wherein the clustering is performed using one or more unsupervised clustering techniques.

14. The method of claim 12, wherein the benchmark information is vehicle odometer information.

15. The method of claim 12, further comprising:
correlating the vehicle data into charge-attempt charging-status (CACS) records descriptive of whether charge attempts defined by the vehicle data were successful or unsuccessful, and whether the charge attempts were single-attempt or multiple-attempt;
assigning reliability scores to the charging stations based on the CACS records; and
updating the ratings of properties of the charging stations to include the reliability scores based on the vehicle data.

16. The method of claim 15, further comprising utilizing an exponential moving average (EMA) to aggregate the reliability scores over time to obtain a more accurate and stable estimate of reliability.

17. The method of claim 15, further comprising filtering the CACS records using a public charger locations database to include only those charging stations identified by the public charger locations database.

18. The method of claim 17, where the filtering includes to assign each CACS record of the CACS records to a closest charging station in the public charger locations database that is within a predefined threshold radius from a location specified by the CACS record.

19. A non-transitory computer-readable medium comprising instructions for customer-centric dynamic charging station assessment that, when executed by one or more computing devices, cause the one or more computing devices to perform operations including to:
receive a charger request from a vehicle, the charger request including an identifier of a sender of the charger request and a location of the vehicle;
identify one or more charging stations in proximity to the location of the vehicle;
for each identified charging station, compute a user-specific charger score using a plurality of charging station scores for the charging station weighted according to user weights corresponding to the identifier; and
send a charger recommendation to the vehicle responsive to the charger request, the charger recommendation including, for each of the one or more charging stations, a location of the charging station and the user-specific charger score corresponding to the charging station.

20. The medium of claim 19, further comprising instructions that, when executed by the one or more computing devices, cause the one or more computing devices to perform operations including to:
receive vehicle data from a plurality of vehicles, the vehicle data being descriptive of charging events of the plurality of vehicles at a plurality of charging stations;
aggregate the vehicle data into charger visits (CV) records according to benchmark information included in the vehicle data;
perform clustering of CV records in view of ratings of properties of the charging stations to categorize the vehicle data into user behaviors; and
determine the user weights according to the clustering.

21. The medium of claim 20, wherein the clustering is performed using one or more unsupervised clustering techniques.

22. The medium of claim 20, wherein the benchmark information is vehicle odometer information.

23. The medium of claim 20, further comprising instructions that, when executed by the one or more computing devices, cause the one or more computing devices to perform operations including to:
correlate the vehicle data into charge-attempt charging-status (CACS) records descriptive of whether charge attempts defined by the vehicle data were successful or unsuccessful, and whether the charge attempts were single-attempt or multiple-attempt;
assign reliability scores to the charging stations based on the CACS records; and
update the ratings of properties of the charging stations to include the reliability scores based on the vehicle data.

24. The medium of claim 23, further comprising instructions that, when executed by the one or more computing devices, cause the one or more computing devices to perform operations including to utilize an exponential moving average (EMA) to aggregate the reliability scores over time to obtain a more accurate and stable estimate of reliability.

25. The medium of claim 24, further comprising instructions that, when executed by the one or more computing devices, cause the one or more computing devices to perform operations including to filter the CACS records using a public charger locations database to include only those charging stations identified by the public charger locations database, where the filtering includes to assign each CACS record of the CACS records to a closest charging station in the public charger locations database that is within a predefined threshold radius from a location specified by the CACS record.
